(19) United States
(12) Patent Application Publication
(10) Pub. No.: US 2012/0056043 A1
(43) Pub. Date: Mar. 8, 2012

(54) FASTENER FOR MOUNTING ULTRASONIC SENSOR MODULE AND METHOD FOR FASTENING

(76) Inventors: Satoru Inoue, Tokyo (JP); Yukio Nishimoto, Tokyo (JP)

(21) Appl. No.: 13/318,427

(22) PCT Filed: Feb. 19, 2010
(86) PCT No.: PCT/JP2010/001085

§ 371 Date: Nov. 1, 2011

(51) Int. Cl. F16M 13/02; B23P 17/04

(52) U.S. Cl. 248/27.1; 29/428

(57) ABSTRACT

An ultrasonic sensor module 1 is inserted into an attaching hole 7 provided in a bumper 6 of a vehicle to be thereby temporarily positioned therein, then a fixing ring plate, which is formed by fitting a holding section 4 in a hole 3a of a fixing section 3 and further connecting the holding section and the fixing section to each other with a fitting section 5, is mounted to the ultrasonic sensor module 1 from the back of the bumper 6, and the fixing section 3 is fixed to the back of the bumper 6 through an adhesive member 11 while pressing a flange 9 of the ultrasonic sensor module 1 with the holding section 4.

### TECHNICAL FIELD

The present invention relates to an attaching device and an attaching method for attaching an ultrasonic sensor module to, for example, a bumper of a vehicle.

### BACKGROUND ART

Conventionally, for the types of attaching device and attaching method, as shown in Patent Document 1, it is arranged that a holding section of an ultrasonic sensor module is disposed on the back of a bumper of a vehicle, the ultrasonic sensor module is housed in the holding section from the back of the bumper, and the surface of amounting section of the ultrasonic sensor module that projects from the end of the holding section is disposed so as to be flush with the surface of the bumper.

### PRIOR ART DOCUMENTS

### Patent Documents

Patent Document 1: Japanese Patent No. 4056568

### SUMMARY OF THE INVENTION

However, in the arrangement disclosed in the above Patent Document 1, when a holding section of an ultrasonic sensor module on the back of a bumper of a vehicle is disposed, a hole of the bumper requires an alignment (jig) of the holding section with respect to the hole of the bumper such that a mounting section of the ultrasonic sensor module to be housed in the holding section can be inserted in the hole of the bumper; thus, there is a problem such that the attaching work is not easy.

The present invention has been made to solve the above-mentioned problems, and an object of the invention is to provide an ultrasonic sensor module attaching device and an ultrasonic sensor module attaching method that eliminate the necessity of positioning an ultrasonic sensor module with respect to a hole of a bumper, and that can easily attach the ultrasonic sensor module to the back of the bumper.

An ultrasonic sensor module attaching device according to the present invention includes an ultrasonic sensor module having a flange of which the diameter is larger than the hole-diameter of a through hole provided in a bumper of a vehicle; a fixing section to be fixed to the back of the bumper in a position to come in contact with the outer peripheral portion of the flange of the ultrasonic sensor module; a holding section for holding the flange of the ultrasonic sensor module by pressing the flange against the back of the bumper; and a fitting section for connecting the fixing section and the holding section to each other.

According to the invention, with the above arrangement, thus, it is possible to easily attach the ultrasonic sensor module to the back of the bumper.

Further, the ultrasonic sensor module attaching method according to the invention includes the steps of inserting an ultrasonic sensor module, having a flange of which the diameter is larger than the hole-diameter of a through hole provided in a bumper of a vehicle, into the through hole to thereby temporarily position the module therein; then mounting a fixing ring plate to the ultrasonic sensor module from the back of the bumper, with the fixing ring plate being formed by fitting a ring-shaped holding section, having an external diameter substantially the same as that of the flange, into a hole which has an diameter larger than the external diameter of the flange of the ultrasonic sensor module, and which is provided in a fixing section, to be connected with a fitting section; and fixing the fixing section to the back of the bumper while pressing the flange of the ultrasonic sensor module with the holding section.

According to the invention, with the above-discussed procedure, the necessity of aligning (centering) the fixing section and the holding section with respect to the hole of the bumper can be eliminated, and thus the ultrasonic sensor module can be easily attached to the back of the bumper.

### BRIEF DESCRIPTION OF THE DRAWINGS

FIG. 1 is a side view explaining an attaching method (1) of an ultrasonic sensor module according to a first embodiment of the present invention.

FIG. 2 is a side view explaining an attaching method (2) of an ultrasonic sensor module according to the first embodiment of the invention.

FIG. 3 is a side view explaining an attaching method (3) of an ultrasonic sensor module according to the first embodiment of the invention.

FIG. 4 is a front view showing an arrangement of an attaching device in a state where a fixing section is mounted to an ultrasonic sensor module.

FIG. 5 is a front view showing an arrangement of the attaching device in a state where the fixing section and a holding section are mounted to the ultrasonic sensor module.

FIG. 6 is a view showing an arrangement of a slide type of fitting section; FIG. 6(a) and FIG. 6(b) show the arrangement on the side of the holding section, and FIG. 6(c) and FIG. 6(d) show the arrangement on the side of the fixing section.

FIG. 7 is a sectional view showing an arrangement of a fitting section of an attaching device according to a second embodiment of the invention.

FIG. 8 is a front view showing an arrangement of an attaching device according to a third embodiment of the invention, and is a front view showing a state where a holding section is not yet mounted thereto.

FIG. 9 is a front view showing an arrangement of an attaching device according to a fourth embodiment of the invention, and is a front view showing a state where a holding section is not yet mounted thereto.

FIG. 10 is an external perspective view showing arrangements of a fixing section and the holding section shown in FIG. 8.

FIG. 11 shows an arrangement of a fitting section shown in FIG. 8; FIG. 11(a) is a front view thereof, and FIG. 11(b) is a side view thereof.

FIG. 12 is a front view showing a modification of an attaching device according to the fourth embodiment of the invention.

### BEST MODE FOR CARRYING OUT THE INVENTION

In the following, embodiments of the present invention will be described with reference to the accompanying drawings in order to explain the present invention in more detail.

### First Embodiment

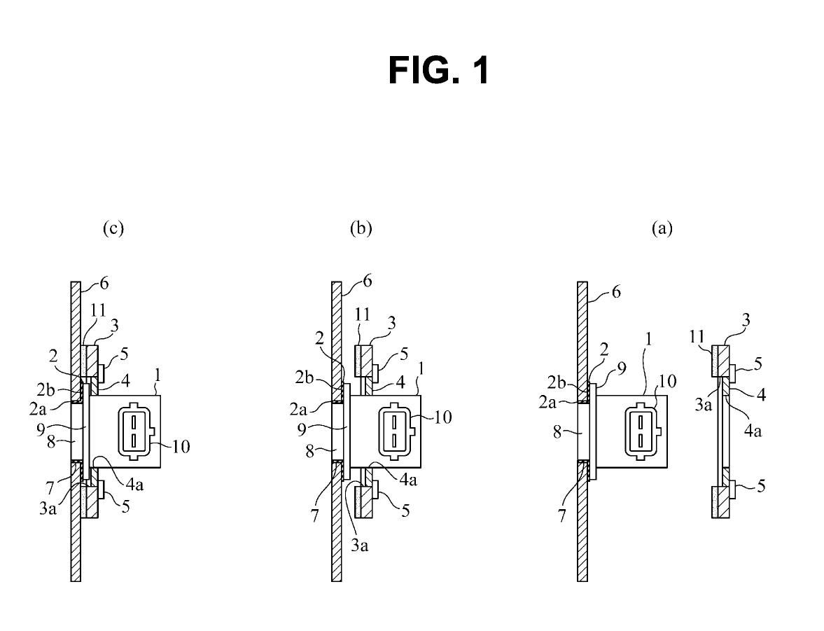

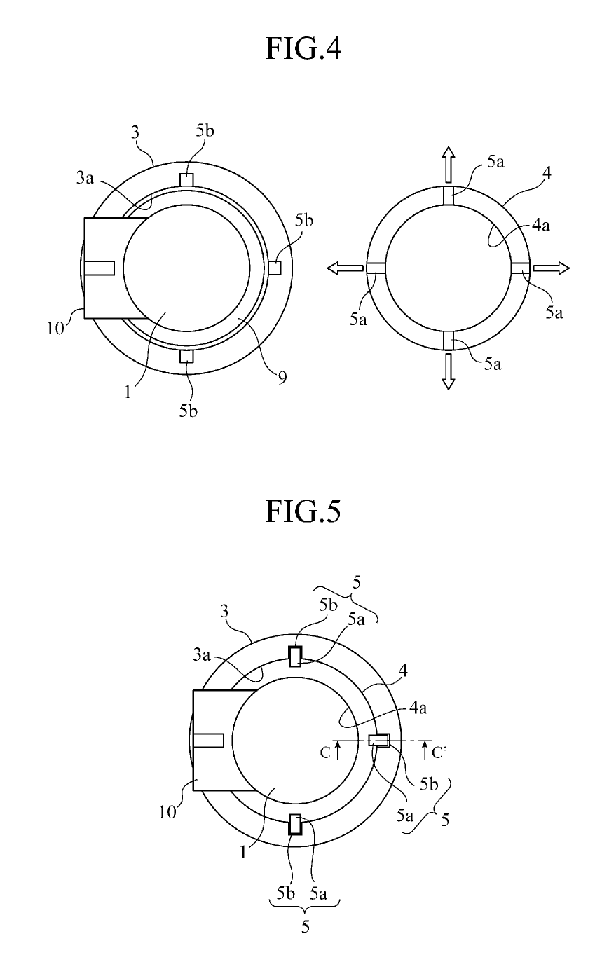

FIG. 1 to FIG. 3 show methods (1) to (3) for attaching an ultrasonic sensor module to a bumper with an attaching device according to a first embodiment, respectively. The attaching device of the present invention has an ultrasonic sensor module 1; an interference preventing resilient body 2; and a fixing ring plate composed of a fixing section 3, a holding section 4, and a fitting section 5. FIG. 4 shows a front view of the attaching device in a state where the fixing section 3 is mounted to the ultrasonic sensor module 1, and FIG. 5 shows a front view of the attaching device in a state where the fixing section 3 and the holding section 4 are mounted to the ultrasonic sensor module 1.

The ultrasonic sensor module 1 is formed in a shape such that amounting section 8 to a bumper 6 of a vehicle is insertion-engaged with an attaching hole 7 formed in the bumper 6, and also a flange 9 having a diameter larger than that of the attaching hole 7 is formed at the base portion of the mounting section 8 thereof. Further, a connector 10 is provided protrusively on the outer peripheral surface of the ultrasonic sensor module 1.

The interference preventing resilient body 2 is made of, e.g., silicone rubber or the like, and has a tubular section 2a into which the mounting section 8 of the ultrasonic sensor module 1 is inserted and a plane section 2b for covering the surface of the flange 9 opposing the bumper 6.

The fixing ring plate is formed with a fitting section 5 that connects the fixing section 3 and the holding section 4 to each other. The fixing section 3 has a ring shape having a hole 3a of which the diameter is substantially the same as the outer diameter of the flange 9 in the center thereof, and is adhesion-fixed to the back of the bumper 6 through an adhesive member 11. The holding section 4 has a ring shape having a hole 4a of which the diameter is substantially the same as the outer diameter of the ultrasonic sensor module 1 in the center thereof, and presses and holds the flange 9 against the back of the bumper 6 in such a manner as to cover the flange.

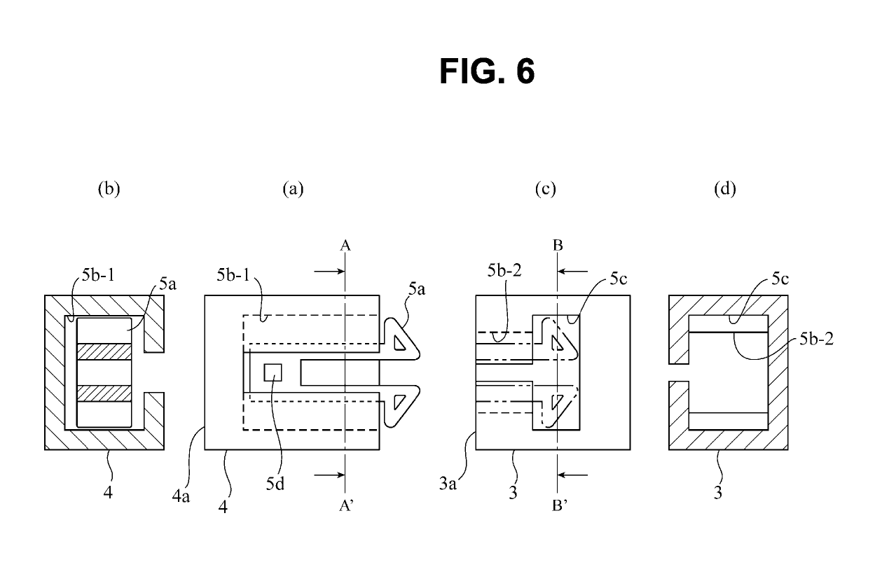

FIG. 6 shows one example of a slide type of fitting section 5. FIG. 6(a) shows one example of the fitting section 5 formed on the side of the holding section 4, and FIG. 6(b) shows a sectional view thereof taken along the line A-A′. FIG. 6(c) shows one example of the fitting section 5 formed on the side of the fixing section 3, and FIG. 6(d) shows a sectional view thereof taken along the line B-B′. A sliding claw 5a made of a resilient material existing in the interior of a slide groove 5b-1 slidingly moves along a slide groove 5b-2 while being inwardly resiliently deformed, and is recovered after passing through the groove to be locked in a fitting hole 5c, thus connecting the holding section 4 and the fixing section 3 to each other. Since the sliding claw 5a is fit in the fitting hole 5c, even if the attaching device receives vibration from the vehicle, the connection between the holding section 4 and the fixing section 3 is not easily broken. To release the connection, the sliding claw 5a is slidingly moved in the direction opposite from that of the engaging motion. A knob 5d is an operational projection for slidingly moving the sliding claw 5a.

Incidentally, in FIG. 6, the sliding claw 5a is formed on the side of the holding section 4, and the fitting hole 5c is formed on the side of the fixing section 3; however, it may be arranged that, contrariwise, the fitting hole 5c is formed on the side of the holding section 4, and the sliding claw 5a is formed on the side of the fixing section 3.

Next, three methods for attaching the ultrasonic sensor module 1 to the bumper 6 of a vehicle will be described.

(1) Attaching Method Shown in FIG. 1:

First, as shown in FIG. 1(a), the fixing section 3 and the holding section 4 are connected to each other with the fitting section 5 to make the fixing ring plate.

Further, the mounting section 8 of the ultrasonic sensor module 1 is covered with the tubular section 2a of the interference preventing resilient body 2, and the surface of the flange 9 is covered with the plane section 2b formed integral with one end of the tubular section 2a. Under such a condition, the mounting section 8 of the ultrasonic sensor module 1 is press-fitted into the attaching hole 7 of the bumper 6, to thereby temporarily position the ultrasonic sensor module 1 in the bumper 6 by the frictional force of the interference preventing resilient body 2. For this securing method, in addition to adhesion or bonding, welding, screw-fixing, and these combination combined may be used.

Alternatively, the interference preventing resilient body 2 is inserted into the attaching hole 7 provided in the bumper 6 to temporarily fix the interference preventing resilient body 2 therein by the frictional force thereof. Thereafter, the mounting section 8 of the ultrasonic sensor module 1 is press-fit into the interference preventing resilient body 2 that is temporarily fixed in the attaching hole 7 of the bumper 6, to thereby temporarily position the ultrasonic sensor module 1 in the bumper 6 by the frictional force of the interference preventing resilient body 2.

Then, as shown in FIG. 1(b), the fixing ring plate is inclined, and the connector 10 provided protrudingly on the outer peripheral surface of the ultrasonic sensor module 1 is passed through the hole 3a to mount the fixing ring plate to the ultrasonic sensor module 1; then, the fixing ring plate is kept perpendicular to the ultrasonic sensor module 1, the hole 3a is moved along the outer periphery of the ultrasonic sensor module 1 toward the back of the bumper 6 as shown in FIG. 1(c), and the fixing ring plate is adhesion-secured to the bumper through the adhesive member 11 that is provided on the fixing section 3.

According to the attaching method, the ultrasonic sensor module 1 is first temporarily positioned in the attaching hole 7 of the bumper 6; thus, only when the insertion of the fixing ring plate is carried out along the outer periphery of the ultrasonic sensor module 1, the fixing section 3 and the holding section 4 can be positioned therein.

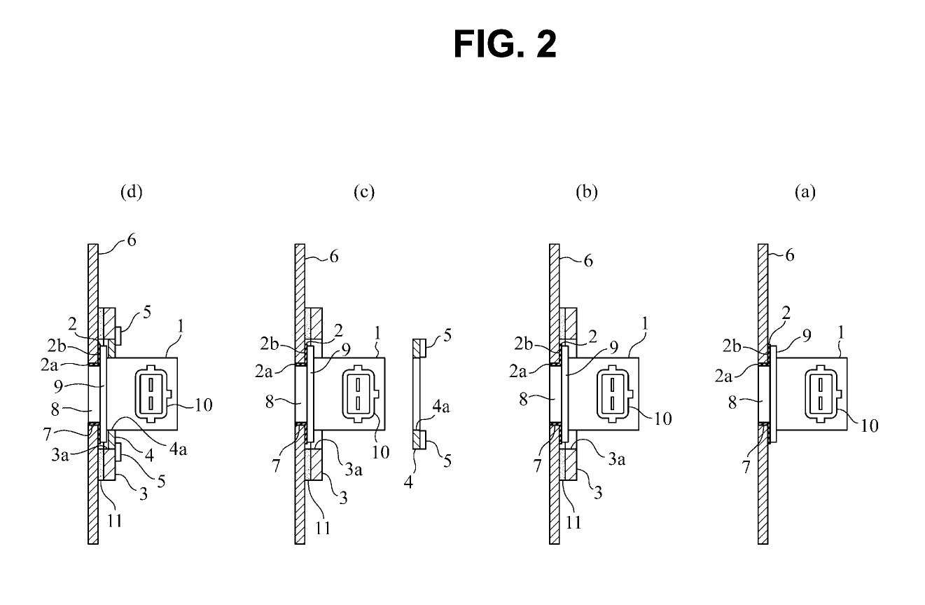

(2) Attaching Method Shown in FIG. 2:

First, as shown in FIG. 2(a), the ultrasonic sensor module 1 is temporarily positioned in the bumper 6. Then, as shown in FIG. 2(b), the fixing section 3 is inclined to pass the connector 10 through the hole 3a to be mounted to the ultrasonic sensor module 1; thereafter, the fixing section is moved toward the back of the bumper 6 with perpendicular to the ultrasonic sensor module 1; the fixing section is positioned in contact with the outer peripheral portion of the flange 9, and then the fixing section is fixed to the back of the bumper 6 through the adhesive member 11.

Thereafter, as shown in FIG. 2(c) and FIG. 2(d), the holding section 4 is inclined to pass the connector 10 through the hole 4a to be mounted to the ultrasonic sensor module 1; subsequently, the holding section is moved toward the back of the bumper 6 with perpendicular to the ultrasonic sensor module 1, and pressed against the back of the flange 9; then, the sliding claw 5a (not shown) of the fitting section 5 is slidingly moved to connect the holding section 4 to the fixing section 3, and thereby, the ultrasonic sensor module 1 is held by the integrated fixing ring plate.

According to the attaching method, since the ultrasonic sensor module 1 is first temporarily positioned in the attaching hole 7 of the bumper 6, the fixing section 3 can be positioned with the flange 9 of the ultrasonic sensor module 1 as a reference.

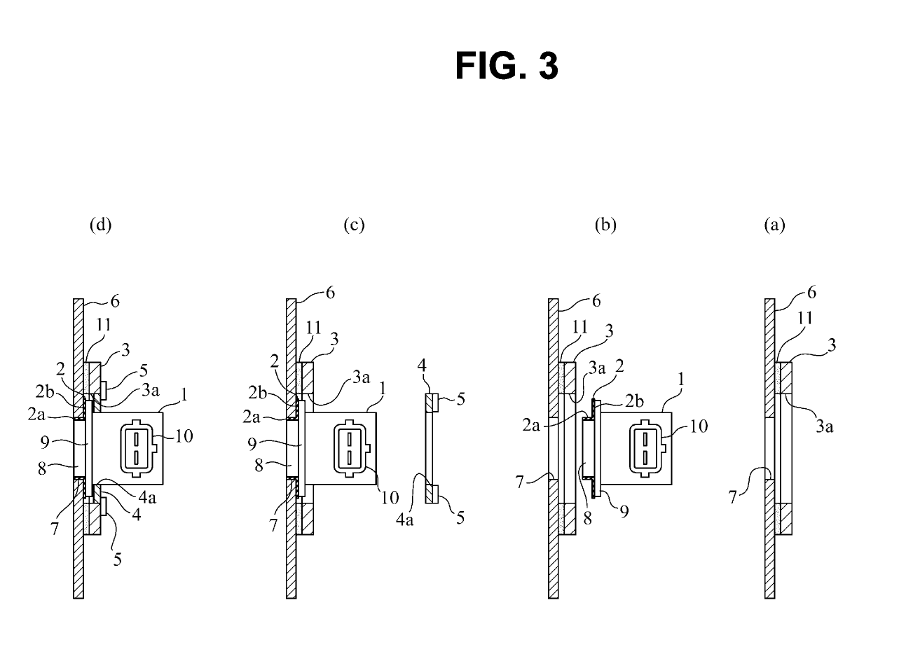

(3) Attaching Method Shown in FIG. 3:

First, as shown in FIG. 3(a), the fixing section 3 is positioned around the attaching hole 7 on the back of the bumper 6 with a centering tool (jig), and adhesion-fixed therearound with the adhesive member 11. Thereafter, as shown in FIG. 3(b), the ultrasonic sensor module 1 covered with the interference preventing resilient body 2 is press-fitted into the attaching hole 7, to thereby temporarily position the ultrasonic sensor module 1 in the bumper 6 by the frictional force of the interference preventing resilient body 2.

Thereafter, as shown in FIG. 3(c) and FIG. 3(d), the holding section 4 is inclined to pass the connector 10 through the hole 4a to be mounted to the ultrasonic sensor module 1; then, the holding section is moved toward the back of the bumper 6 with perpendicular to the ultrasonic sensor module 1, and pressed against the back of the flange 9; the sliding claw 5a (not shown) of the fitting section 5 is slidingly moved to connect the holding section 4 to the fixing section 3, and thereby, the ultrasonic sensor module 1 is held by the integrated fixing ring plate.

According to the attaching method, the adhesion work of the fixing section 3 is carried out under the condition where the ultrasonic sensor module 1 is not yet press-fitted into the attaching hole 7; thus, the adhesion work is easily performed.

Incidentally, in any of the attaching methods (1) to (3), when the connection between the fixing section 3 and the holding section 4 is released by slidingly operating the fitting section 5, the ultrasonic sensor module 1 can be removed; thus, the ultrasonic sensor module 1 can be easily detached therefrom.

As discussed above, according to the first embodiment, the attaching device is arranged to include: the ultrasonic sensor module 1 provided with the flange 9 of which the diameter is larger than the hole-diameter of the attaching hole 7 provided in the bumper 6 of a vehicle; the fixing section 3 fixed to the back of the bumper 6 through the adhesive member 11 in a position to come in contact with the outer peripheral portion of the flange 9 of the ultrasonic sensor module 1; the holding section 4 which holds the flange 9 of the ultrasonic sensor module 1 by pressing the flange against the back of the bumper 6; and the fitting section 5 for connecting the fixing section 3 and the holding section 4 to each other. Therefore, the ultrasonic sensor module 1 can be easily attached to the back of the bumper 6.

Further, the attaching procedures includes the steps of: inserting the ultrasonic sensor module 1 into the attaching hole 7 provided in the bumper 6 of a vehicle to be thereby temporarily positioned therein; then mounting the fixing ring plate, which is formed by fitting the holding section 4 in the hole 3a of the fixing section 3 to be connected with the fitting section 5, to the ultrasonic sensor module 1 from the back of bumper 6; and fixing the fixing section 3 to the back of the bumper 6 through the adhesive member 11 while pressing the flange 9 of the ultrasonic sensor module 1 using the holding section 4. Therefore, without the necessity of aligning (centering) the fixing section 3 and the holding section 4 with respect to the attaching hole 7 of the bumper 6, the ultrasonic sensor module 1 can be easily attached to the back of the bumper.

Further, the slide type of fitting section 5 is arranged to have the slide groove 5b provided in the fixing section 3, and the sliding claw 5a provided in the holding section 4 and sliding and fitting into the slide groove 5b; thus, the fitting section can be achieved with a simple mechanism.

### Second Embodiment

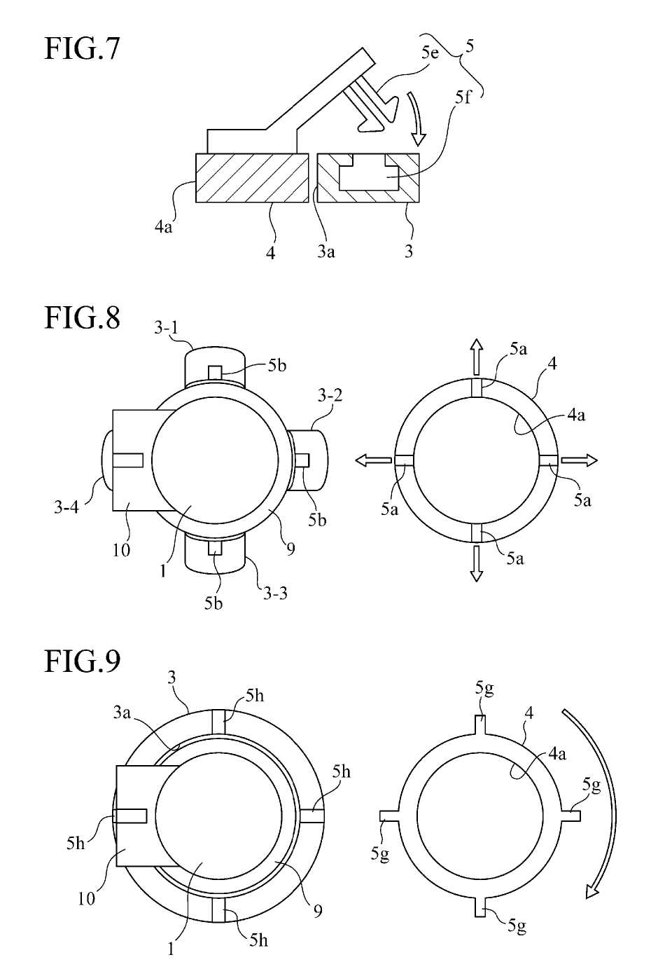

In a second embodiment, a fit-in type of fitting section 5 is employed in place of the slide type of fitting section 5 in the first embodiment. FIG. 7 shows an example of a fit-in type of fitting section 5 consisting of an fitting claw 5e and a fitting hole 5f. The figure is a sectional view taken along the line corresponding to the line C-C′ shown in FIG. 5. The fitting claw 5e made of a resilient material formed in the holding section 4 is resiliently deformed to fit in the fitting hole 5f formed in the fixing section 3, thus connecting the holding section 4 and the fixing section 3 to each other. The fit between the fitting claw 5e and the fitting hole 5f renders it difficult to break the connection between the holding section 4 and the fixing section 3, even if the attaching device receives vibration from the vehicle. To release the connection therebetween, the fitting claw 5e is moved upwardly from the fitting hole 5f.

Incidentally, in FIG. 7, the fitting claw 5e is formed on the side of the holding section 4, and the fitting hole 5f is formed on the side of the fixing section 3; however, it may be arranged that, in a reverse manner, the fitting hole 5f is formed on the side of the holding section 4, and the fitting claw 5e is formed on the side of the fixing section 3. Further, also in the case of the fit-in type of fitting section 5, the attaching methods (1) to (3) according to the first embodiment can be used.

As discussed above, according to the second embodiment, the fit-in type of fitting section 5 is arranged to have the fitting hole 5f provided in the fixing section 3, and the fitting claw 5e provided in the holding section 4 and fit in the fitting hole 5f; thus, the fitting section can be achieved with a simple mechanism.

### Third Embodiment

In a third embodiment, the fixing section 3 in the first embodiment is divided into a plurality of parts, plates 3-1 to 3-4 shown in FIG. 8. For a fitting section 5, both of the slide type according to the first embodiment and the fit-in type according to the second embodiment can be employed, and one fitting section is provided for each of the plates 3-1 to 3-4. By using the individual plates 3-1 to 3-4, the fixing section can be easily disposed in conformity with the shape of the bumper 6, and thus the fixing section can be easily adhesion-secured to the bumper 6 having a curved shape.

Hereupon, also in the case where the fixing section is composed of plates 3-1 to 3-4, the attaching methods (1) to (3) according to the first embodiment can be employed. Particularly, in the attaching method (1), the plates 3-1 to 3-4 and the holding section 4 are connected to each other with the fitting sections 5 to form a fixing ring plate, and then the fixing ring plate is mounted to the ultrasonic sensor module 1. Thus, the method (1) increases the ability of the attaching device to be operated as compared with the attaching methods (2), and (3).

As discussed above, according to the third embodiment, it is arranged that the fixing section consist of a plurality of plates 3-1 to 3-4, which are disposed along the outer peripheral portion of the flange 9 of the ultrasonic sensor module 1; thus, even when the bumper 6 has a curved shape, the fixing section can be easily adhesion-secured thereto.

### Fourth Embodiment

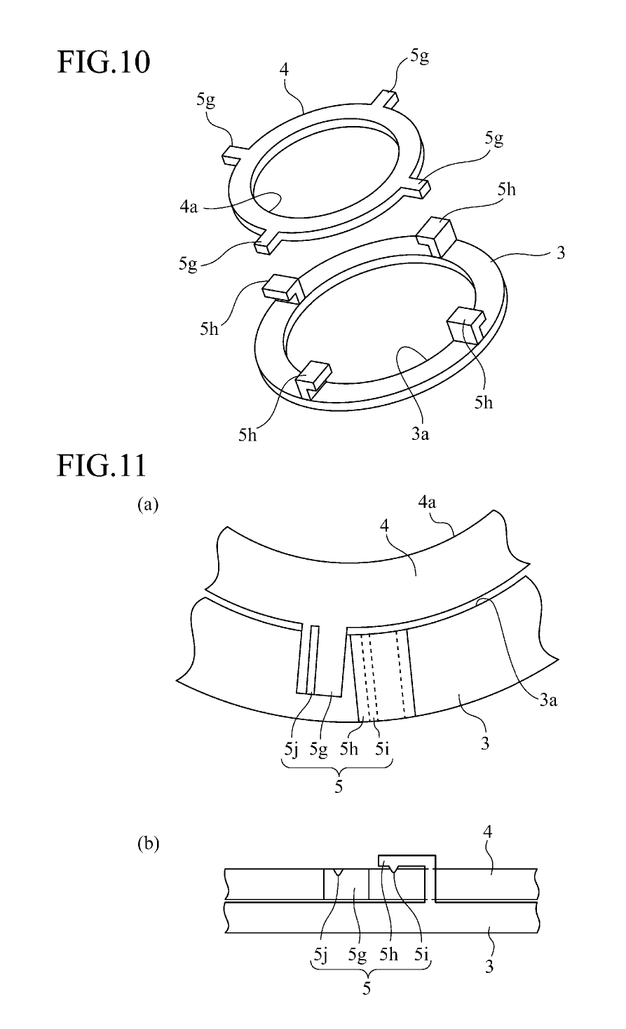

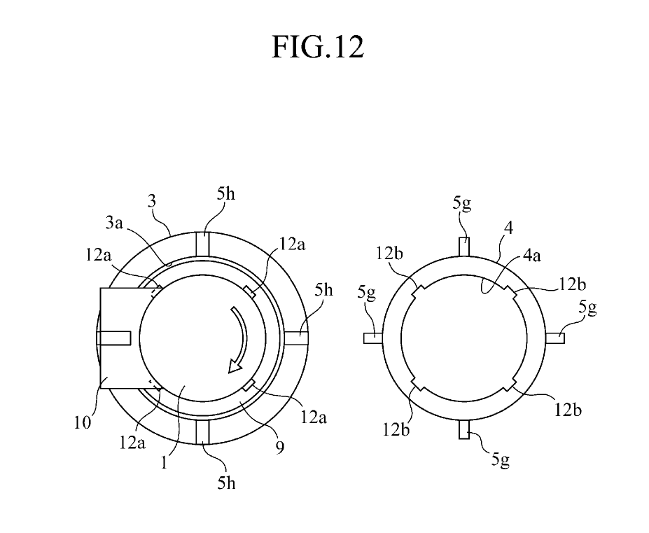

In a fourth embodiment, a rotary type of fitting section 5 is employed in place of the slide type of fitting section 5 of the first embodiment or the fit-in type of the second embodiment. FIG. 9 shows an attaching device provided with the rotary type of fitting section 5, FIG. 10 shows the external perspective view of the fitting section 5, FIG. 11(a) is a front view thereof, and FIG. 11(b) is a side view thereof. The rotary type of fitting section 5 is composed of fitting projections 5g, fitting receiving sections 5h, detent projections 5i, and detents 5j. In connecting the fixing section 3 and the holding section 4 to each other, when one section is rotated to the other section, the fitting projections 5g formed on the holding section 4 fit in their respective fitting receiving sections 5h made of a resilient material, formed on the fixing section 3 while resiliently deforming and upwardly forcing their respective ones. In the fitting state, the detent projection 5i formed in the fitting receiving section 5h is fitted in the detent recess 5j formed in the fitting projection 5g, and thus even if the attaching device receives vibration from the vehicle, the connection between the holding section 4 and the fixing section 3 is not easily broken. To release the connection, the holding section 4 is rotated in the direction opposite from the connecting direction.

Hereupon, in FIG. 9 to FIG. 11, the fitting projections 5g are formed on the side of the holding section 4, and the fitting receiving sections 5h are formed on the side of the fixing section 3; however, contrariwise, the fitting receiving sections 5h may be formed on the side of the holding section 4, and the fitting projections 5g may be formed on the side of the fixing section 3. Moreover, also in the case of the rotary type of fitting section 5, the attaching methods (1) to (3) according to the first embodiment can be used.

As discussed above, according to the fourth embodiment, the rotary type of fitting section 5 is arranged to have the fitting projections 5g provided protrudingly on the outer peripheral side of the holding section 4 and the fitting receiving sections 5h, which are provided on the fixing section 3 and in which their respective fitting projections 5g are fit by relatively rotating the fixing section 3 and the holding section 4; thus, the fitting section can be achieved with a simple mechanism. Further, since the rotary type of fitting section 5 can be fit therein by a rotating operation of one process, it is easy to connect the fixing section 3 and the holding section 4, as compared with the slide type and the fit-in type of fitting sections 5.

Additionally, it may be arranged that a fitting structure is provided between the ultrasonic sensor module 1 and the holding section 4 in the attaching device of the fourth embodiment. The fitting structure has fitting projections 12a provided protrudingly on the outer peripheral surface of the ultrasonic sensor module 1 and recesses 12b formed on the side of the hole 4a of the holding section 4. When the holding section 4 is mounted to the ultrasonic sensor module 1 and then the projections 12a and the recesses 12b are engaged with each other, by rotation of the ultrasonic sensor module 1, the holding section 4 is also rotated integrally therewith, and the rotary type of fitting section 5 connects the fixing section 3 and the holding section 4 to each other. As compared with the case where the holding section 4 is directly rotated to bring the rotary type of fitting section 5 in a fitting condition, when the fitting structure is provided therebetween and the ultrasonic sensor module 1 is rotated to thereby bring the rotary type of fitting section 5 into a fitting condition, the rotation operation becomes easier; thus, the fixing section 3 and the holding section 4 can be more easily connected to each other.

Further, in the first to the fourth embodiments, it is arranged that the four fitting sections 5 each are brought into a fitting condition, which may be achieved by three or less and five or more fitting sections. Furthermore, as the constitutional examples of the fitting section 5, the slide type, the fit-in type, and the rotary type of fitting sections are shown in the figures. However, specific arrangements are not limited to the ones of the embodiments discussed above, and it is apparent that those having design changes and modifications made without departing from the spirit and scope of the present invention are included in the scope thereof.

### INDUSTRIAL APPLICABILITY

As discussed above, the ultrasonic sensor module attaching device according to the present invention is composed of the fixing section adhered to a bumper; the holding section for holding the ultrasonic sensor module; the fitting section for connecting the fixing section and the holding section to each other; thus, the ultrasonic sensor module attaching device is suitable for attaching an ultrasonic sensor module to a bumper of a vehicle.

1. An ultrasonic sensor module attaching device comprising:
an ultrasonic sensor module having a flange of which the diameter is larger than the hole-diameter of a through hole provided in a bumper of a vehicle;
a fixing section to be fixed to the back of the bumper in a position where the fixing section comes in contact with the outer peripheral portion of the flange of the ultrasonic sensor module;
a holding section for holding the flange of the ultrasonic sensor module by pressing the flange thereof against the back of the bumper; and
a fitting section for connecting the fixing section and the holding section to each other.

2. The ultrasonic sensor module attaching device according to claim 1, wherein the fixing section is formed in the shape of a ring that encloses the outer peripheral portion of the flange of the ultrasonic sensor module.

3. The ultrasonic sensor module attaching device according to claim 1, wherein the fixing section is composed of a plurality of plates, and is disposed along the outer peripheral portion of the flange of the ultrasonic sensor module.

4. The ultrasonic sensor module attaching device according to claim 1, wherein the fitting section has:
a slide groove provided in one of the fixing section and the holding section; and
a sliding claw which is provided in the other of the fixing section and the holding section, and slides and fits into the slide groove.

5. The ultrasonic sensor module attaching device according to claim 1, wherein the fitting section has:
a fitting hole provided in one of the fixing section and the holding section; and
a sliding claw which is provided in the other of the fixing section and the holding section, and fits in the fitting hole.

6. The ultrasonic sensor module attaching device according to claim 1, wherein the fitting section has:
a fitting projection provided in one of the fixing section and the holding section; and
a fitting-receiving section which is provided in the other of the fixing section and the holding section, and has the fitting projection fitted therein by the fixing section and the holding section that are rotated relative to each other.

7. The ultrasonic sensor module attaching device according to claim 6, wherein the ultrasonic sensor module has a fitting projection on the outer peripheral surface thereof, and the holding section has a recess for engaging with the engaging projection, and rotates integrally with the ultrasonic sensor module.

8. An ultrasonic sensor module attaching method comprising the steps of:
inserting an ultrasonic sensor module, having a flange of which the diameter is larger than the hole-diameter of a through hole provided in a bumper of a vehicle, into the through hole to be thereby temporarily positioned therein;
mounting a fixing ring plate to the ultrasonic sensor module from the back of the bumper, with the fixing ring plate being formed by fitting a ring-shaped holding section, having an external diameter substantially the same as that of the flange, into a hole which has an diameter larger than the external diameter of the flange of the ultrasonic sensor module and which is provided in a fixing section, to be thereby connected with a fitting section; and
fixing the fixing section to the back of the bumper while pressing the flange of the ultrasonic sensor module with the holding section.
